(19) United States
(12) Patent Application Publication
(10) Pub. No.: US 2015/0019426 A1
(43) Pub. Date: Jan. 15, 2015

(54) METHOD AND SYSTEM FOR APPLYING SPENDING LIMITS TO PAYMENT ACCOUNTS INVOLVING INSTALLMENT TRANSACTIONS

(71) Applicant: MasterCard International incorporated, Purchase, NY (US)

(72) Inventors: Frederick Michael Pacher, Williston Park, NY (US); Ana Paula Martinez Prada Peyser, Key Biscayne, FL (US); Michael D. McCarthy, New York, NY (US); Flavio Shibao, Sao Paulo (BR); Craig Robert Dinsmore, Des Peres, MO (US); Mary Margaret Williams, Dardenne Prairie, MO (US)

(73) Assignee: MasterCard International Incorporated, Purchase, NY (US)

(21) Appl. No.: 13/940,818

(22) Filed: Jul. 12, 2013

(51) Int. Cl. G06Q 20/40

(52) U.S. Cl. CPC G06Q 20/40
USPC 705/44

(57) ABSTRACT

A method for identifying a spending budget for a payment account includes: storing, in an account database, a plurality of account data entries, each account data entry including at least an account identifier and a base monthly spending limit; storing, in an installment database, a plurality of installment data entries, each installment data entry including at least an account identifier and an installment amount; identifying, for a specific account data entry in the account database, at least one installment data entry where the included account identifier corresponds to the account identifier of the specific account data entry; calculating an effective monthly spending limit based on the base monthly spending limit and the installment amount included in each of the identified at least one installment data entry; and associating, in the account database, the calculated effective monthly spending limit with the specific account data entry.

### FIELD

The present disclosure relates to the use of spending limits on a payment account in conjunction with installment transactions, specifically the calculation of spending limits taking into account ongoing installment transactions.

### BACKGROUND

The frequency of use of payment accounts to fund financial transactions is continually increasing. As society moves towards more technology-based systems, consumers are often using payment cards, smart phones, and other similar devices and methods for funding a financial transaction using an associated payment account. As technology provides consumers with more customization with aspects of their everyday lives, consumers similarly desire increased control and customization of their payment accounts.

In order to provide consumers with more control over payment accounts, methods and systems for the creation, distribution, and use of controlled payment numbers have been developed. Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children, etc. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

Controlled payment numbers may also enable account holders to set budgets for themselves, such as by setting an overall, industry-specific, or merchant-specific monthly spending limit that cannot be exceeded. However, such spending limits typically do not take into account ongoing installment transactions. As a result, an account holder may purchase several items with an attached installment plan, then spend to their monthly spending limit, only to discover that they have exceed their limit once the installments are paid. In such an instance, a consumer is constantly at risk of either exceeding their spending limits, or being unable to afford to keep up with installment payments. As a result, the consumer must either monitor their spending, which frustrates the purpose in establishing a controlled payment number with a spending limit, or adjust their spending limit every month based on installments, which also negates the benefits of using a controlled payment number. This poses a technical problem for the consumer in amassing sufficient information efficiently.

Thus, there is a need for a technical solution to identify and process spending limits for payment accounts that considers ongoing installment transactions.

### SUMMARY

The present disclosure provides a description of systems and methods for the identifying of spending budgets for payment accounts and the processing of financial transactions.

A method for identifying a spending budget for a payment account includes: storing, in an account database, a plurality of account data entries, wherein each account data entry includes data related to a payment account and includes at least an account identifier and a base monthly spending limit; storing, in an installment database, a plurality of installment data entries, wherein each installment data entry includes data related to an ongoing installment transaction and includes at least an account identifier and an installment amount; identifying, for a specific account data entry in the account database, at least one installment data entry wherein the account identifier included in each of the at least one installment data entry corresponds to the account identifier included in the specific account data entry; calculating, by a processing device, an effective monthly spending limit, wherein the effective monthly spending limit is based on the base monthly spending limit and the installment amount included in each of the identified at least one installment data entry; and associating, in the account database, the calculated effective monthly spending limit with the specific account data entry.

A method for processing a financial transaction includes: storing, in an account database, a plurality of account data entries, wherein each account data entry includes data related to a payment account and includes at least an account identifier associated with the related payment account, a monthly spending limit, and a monthly spending amount; storing, in an installment database, a plurality of installment data entries, wherein each installment data entry includes data related to an installment transaction and includes at least a merchant identifier, an installment amount, and an account identifier; receiving, by a receiving device, an authorization request for a financial transaction, wherein the authorization request includes at least a transaction amount and a funding account identifier; identifying, in the account database, a specific account data entry wherein the included account identifier corresponds to the funding account identifier; identifying, in the installment database, at least one installment data entry wherein the account identifier included in each of the at least one installment data entry corresponds to the funding account identifier; calculating, by a processing device, an effective spending amount based on the monthly spending amount and the installment amount for each of the identified at least one installment data entry; and transmitting, by a transmitting device, the authorization request if the calculated effective spending amount is less than the monthly spending limit included in the specific account data entry.

A system for identifying a spending budget for a payment account includes an account database, an installment database, and a processing device. The account database is configured to store a plurality of account data entries, wherein each account data entry includes data related to a payment account and includes at least an account identifier and a base monthly spending limit. The installment database is configured to store a plurality of installment data entries, wherein each installment data entry includes data related to an ongoing installment transaction and includes at least an account identifier and an installment amount. The processing device is configured to: identify, for a specific account data entry in the account database, at least one installment data entry wherein the account identifier included in each of the at least one installment data entry corresponds to the account identifier included in the specific account data entry; calculate an effective monthly spending limit, wherein the effective monthly spending limit is based on the base monthly spending limit and the installment amount included in each of the identified at least one installment data entry; and associate, in the account database, the calculated effective monthly spending limit with the specific account data entry.

A system for processing a financial transaction includes an account database, an installment database, a receiving device, and a processing device. The account database is configured to store a plurality of account data entries, wherein each account data entry includes data related to a payment account and includes at least an account identifier associated with the related payment account, a monthly spending limit, and a monthly spending amount. The installment database is configured to store a plurality of installment data entries, wherein each installment data entry includes data related to an installment transaction and includes at least a merchant identifier, an installment amount, and an account identifier. The receiving device is configured to receive an authorization request for a financial transaction, wherein the authorization request includes at least a transaction amount and a funding account identifier. The processing device is configured to: identify, in the account database, a specific account data entry wherein the included account identifier corresponds to the funding account identifier; identify, in the installment database, at least one installment data entry wherein the account identifier included in each of the at least one installment data entry corresponds to the funding account identifier; and calculate an effective spending amount based on the monthly spending amount and the installment amount for each of the identified at least one installment data entry. The transmitting device is configured to transmit the authorization request if the calculated effective spending amount is less than the monthly spending limit included in the specific account data entry.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the identifying of spending budgets and limits on a payment account and processing of a financial transaction thereof in accordance with exemplary embodiments.

FIG. 2 is a block diagram illustrating the processing server of FIG. 1 for the processing of financial transactions in accordance with exemplary embodiments.

FIG. 3 is a flow diagram illustrating a method for identifying a spending budget for a payment account in accordance with exemplary embodiments.

FIG. 4 is a flow diagram illustrating a method for processing a financial transaction funded by a payment account subject to a spending limit and installment transactions in accordance with exemplary embodiments.

FIGS. 5A and 5B are illustrations of a graphical user interface for setting and reviewing spending limits for a payment account subject to ongoing installment transactions in accordance with exemplary embodiments.

FIG. 6 is a flow chart illustrating an exemplary method for identifying a spending budget for a payment account in accordance with exemplary embodiments.

FIG. 7 is a flow chart illustrating an exemplary method for processing a financial transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

### System for Identifying Spending Limits for a Payment Account

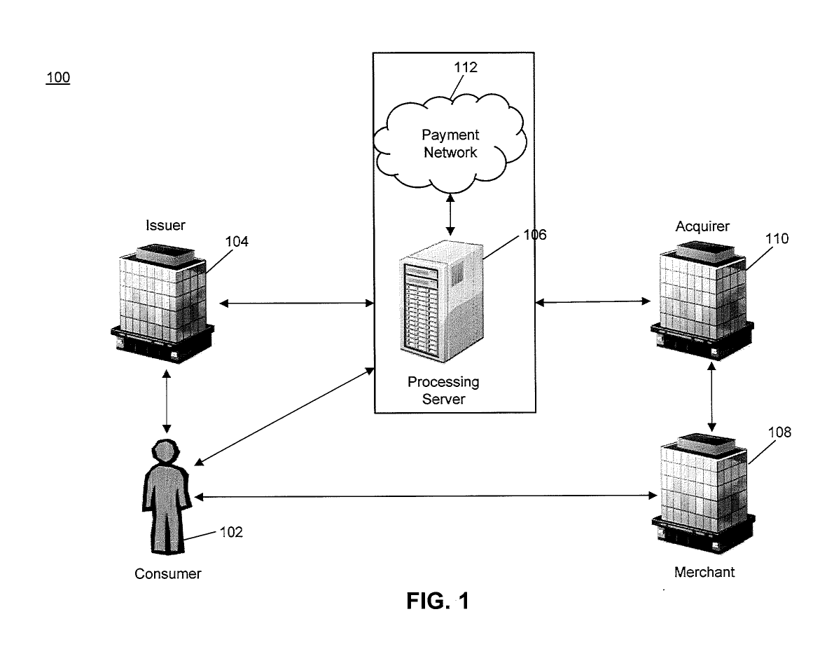

FIG. 1 illustrates a system 100 for identifying spending limits for a payment account involved in ongoing installment transactions.

A consumer 102 may be an account holder for one or more payment accounts issued to the consumer 102 by an issuer 104, such as an issuing bank. Here it should be understood that the consumer 102 includes a communication device or devices used by the consumer, such as mobile phones, tablet computers, PDAs, laptops, desktop computers, computer kiosks, ATMs, etc. The consumer 102 may set a monthly spending limit on one of the one or more payment accounts, where the monthly spending limit is an amount that, if the amount is met, exceeded, or an attempt to exceed it is made, the consumer 102 may receive an alert or other form of notification. For example, if the consumer 102 sets a monthly spending limit of $1,000, has spent $990 during the month, and then attempts to use the account to fund a $20 transaction, the consumer 102 may receive a notification that the monthly spending limit will or has been exceeded.

It will be apparent to persons having skill in the relevant art that the consumer 102 or issuer 104 may set parameters as to events that are to occur when the monthly spending limit is approached or exceeded. In some instances, a transaction that will cause the payment account to exceed the monthly spending limit may be approved, and a notification sent to the consumer 102. In other instances, such a transaction may be denied, and an alert sent to the consumer 102. In yet another instance, the consumer 102 may be prompted for special authorization for any transaction which may result in the exceeding of a monthly spending limit. Other results of the an attempt to exceed or the exceeding of a monthly spending limit will be apparent to persons having skill in the relevant art.

In an exemplary embodiment, the consumer 102 may set the monthly spending limit for a payment account via a processing server 106. The processing server 106, discussed in more detail below, may be configured to store account details regarding the payment account including the monthly spending limit set by the consumer 102. In some embodiments, the processing server 106 may be a part of the issuer 104. In other embodiments, the processing server 106 may be external to the issuer 104 and communicate with the issuer 104 via a network, such as the Internet or a payment network 112. In an exemplary embodiment, the processing server 106 may be part of the payment network 112, which may be configured to process financial transactions. In a further embodiment, the processing server 106 may be further configured to process financial transactions.

The consumer 102 may initiate a financial transaction for the purchase of goods and/or services with a merchant 108. Here, a merchant 108 should be understood as including computer processors, databases and servers permitting the conduct of financial transactions and other services, etc. As part of the initiating of the financial transaction, the consumer 102 may use the payment account to fund the financial transaction, such as by present a payment account number associated with the payment account to the merchant 108 for payment. The merchant 108 may enter transaction details, including the payment information, into a point-of-sale system. The information may then be transmitted to an acquirer 110 associated with the merchant, such as an acquiring bank.

The acquirer 110 may submit an authorization request for the financial transaction to the processing server 106 and/or the payment network 112, as symbolically shown by the box in FIG. 1. Systems and methods for the generation and submission of an authorization request for a financial transaction will be apparent to persons having skill in the relevant art. In one embodiment, the authorization request may be formatted pursuant to the International Organization for Standardization's ISO 8583 standard. In embodiments where the authorization request may be submitted to the payment network 112, the payment network 112 may route the authorization request, or data included therein, to the processing server 106.

The processing server 106 may, using methods discussed in more detail below, identify the payment account used to fund the financial transaction, identify ongoing installment transactions associated with the payment account, and identify an effective monthly spending limit based therein. The processing server 106 may then, based on the identified effective monthly spending limit and a spending amount representing spending already performed in that month, identify an effective spending amount. The effective spending amount may indicate how much the consumer 102 has spent using the payment account including both standard financial transactions and installment transactions.

Then, based on a transaction amount for the financial transaction included in the authorization request, the processing server 106 may either forward the authorization request to the payment network 112 and/or the issuer 104 for approval and/or processing, or may return an authorization response to the acquirer 110 denying the financial transaction. In instances where the authorization request indicates the financial transaction as also being an installment transaction, the processing server 106 may store data related to the financial transaction in an installment database, which may be used to calculate monthly effective spending limits for future transactions. Such a system may enable the consumer 102 to freely transact and stay within a budget set via a monthly spending limit, without unforeseen difficulties due to installment transactions.

### Processing Device

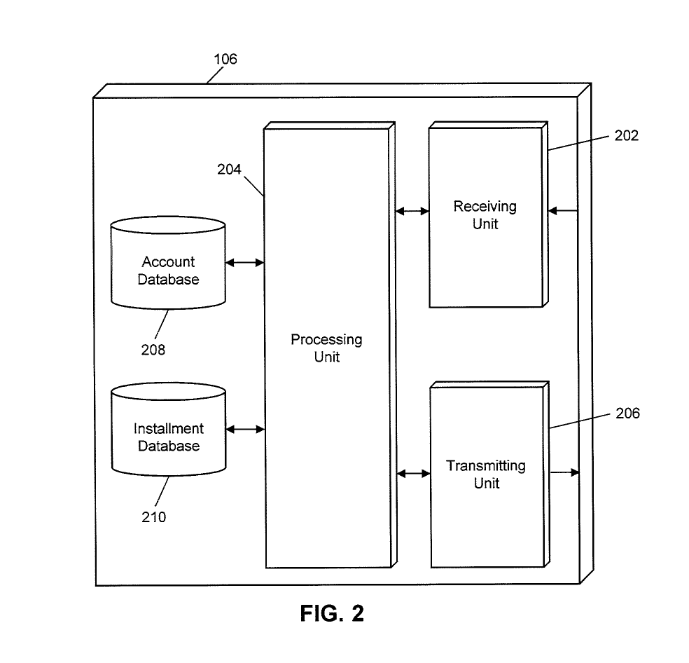

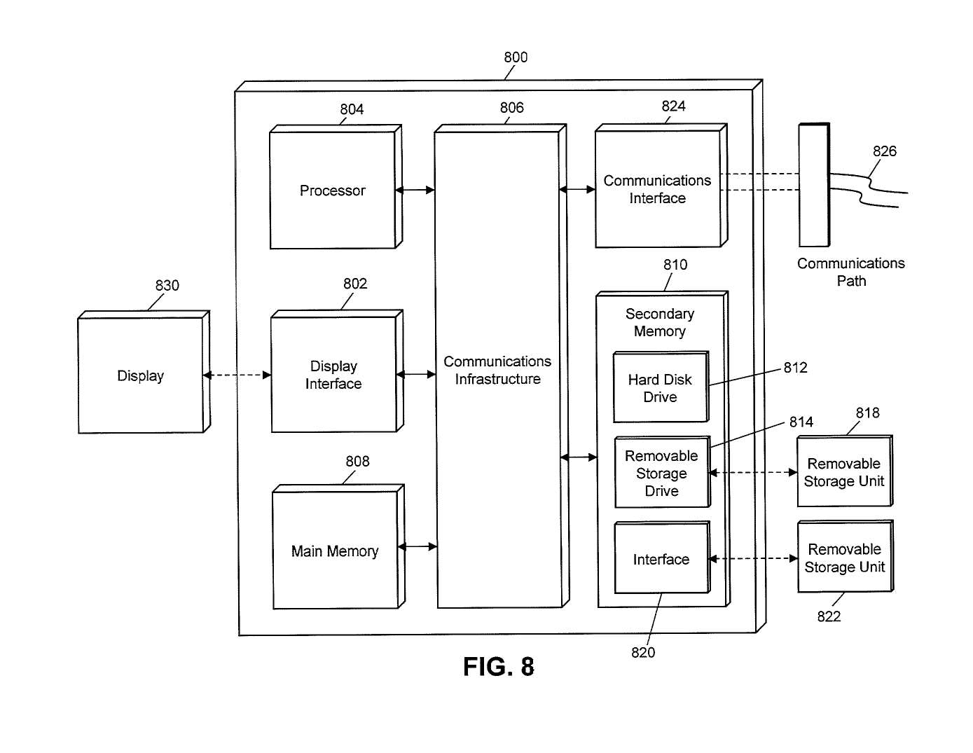

FIG. 2 illustrates an embodiment of the processing server 106 of the system 100. It will be apparent to persons having skill in the relevant art that the embodiment of the processing server 106 illustrated in FIG. 2 is provided as illustration only and may not be exhaustive to all possible configurations of the processing server 106 suitable for performing the functions as discussed herein. For example, the computer system 800 illustrated in FIG. 8 and discussed in more detail below may be a suitable configuration of the processing server 106.

The processing server 106 may include a receiving unit 202. The receiving unit 202 may be configured to receive an authorization request for a financial transaction, such as from the acquirer 110 or the payment network 112. The receiving unit 202 may be configured to receive data via one or more communication protocols, and may be configured to communicate via a network, such as a local area network (LAN), the Internet, a mobile communication network, etc.

The processing server 106 may also include a processing unit 204. The processing unit 204 may be configured to identify data included in the authorization request received by the receiving unit 202, such as an account number associated with a payment account (e.g., for which the consumer 102 is an account holder). The processing server 106 may also include an account database 208. The account database 208 may be configured to store a plurality of account data entries, each account data entry including at least an account identifier associated with a related payment account and a base monthly spending limit.

The account identifier may be any unique value suitable for identifying the associated payment account, such as a payment account number, a controlled payment number, a username, a phone number, an e-mail address, etc. Value suitable for use as the account identifier will be apparent to persons having skill in the relevant art. In some embodiments, each account data entry may further include a monthly spending amount, which may represent an amount already spent during the month using the related payment account, which may be subject to the base monthly spending limit. The processing server 106 may be configured to identify, in the account database 208, an account data entry where the included account identifier corresponds to the account identifier identified in the authorization request.

The processing server 106 may also include an installment database 210. The installment database 210 may include a plurality of installment data entries, each installment data entry including data related to an ongoing installment transaction including at least an account identifier and an installment amount. The receiving unit 202 of the processing server 106 may be configured to receive information regarding new installment transactions, which may be then stored in the installment database 210 as new installment data entries by the processing unit 204. The processing unit 204 may also be configured to identify, in the installment database 210, one or more installment data entries where the included account identifier corresponds to the account identifier included in the authorization request.

The processing unit 204 may then calculate an effective monthly spending limit based on the base monthly spending limit included in the identified account data entry, and the installment amount included in the identified one or more installment data entries. The effective monthly spending limit may thus represent the spending limit available to the associated consumer 102 once all ongoing installments are taken into account. Such a system may enable the consumer 102 to continue to operate within a budget using their previously set base monthly spending limit, without the need to continually monitor installment transactions or change the spending limit each month based on installments.

In some embodiments, the processing unit 204 may also be configured to calculate an effective spending amount for the specific account data entry previously identified. The effective spending amount may be based on the installment amounts included in each of the identified one or more installment data entries and the monthly spending amount included in the specific account data entry. The effective spending amount may represent the total amount funded by the related payment account including both standard and installment transactions. In an alternative embodiment, the effective spending amount may be calculated based on the effective monthly spending limit and the monthly spending amount and may thus represent the amount left that may be spent by the consumer 102 without exceeding the base monthly spending limit.

The processing unit 204 may then identify, based on a transaction amount for the financial transaction included in the authorization request and the effective monthly spending amount, if the monthly spending limit for the payment account will be exceeded if the financial transaction were to be processed. In the limit will not be exceeded, then a transmitting unit included in the processing server 106 may transmit the authorization request for further processing, such as to the issuer 104 or payment network 112. In some embodiments, the processing unit 204 may process the financial transaction, and the transmitting unit 206 may transmit an authorization response indicating approval and successful processing of the financial transaction.

If the limit would be exceeded by the financial transaction, then, in some embodiments, the transmitting unit 206 may transmit an authorization response indicating denial of the financial transaction to the acquirer 110 and/or the merchant 108. In a further embodiment, the transmitting unit 206 may also transmit a notification or alert to the consumer 102 and/or the issuer 104, indicating the denial of the financial transaction due to the exceeding of the spending limit. In an alternative embodiment, the transmitting unit 206 may transmit the authorization request to the issuer 104 for approval or denial of the financial transaction. The receiving unit 202 may receive the response from the issuer 104, and then the transmitting unit 206 may forward the response to the acquirer 110 and may also transmit a notification to the consumer 102 if the transaction, which will result in the limit being exceeded, was approved.

In some instances, the received authorization request may be for an installment transaction, which may be indicated by, for example, a data element included in the authorization request. In such an instance, if the authorization request is approved, the processing unit 204 may generate a new installment data entry for storage in the installment database 210 based on the information included in the authorization request.

### Method for Identifying Spending Limits

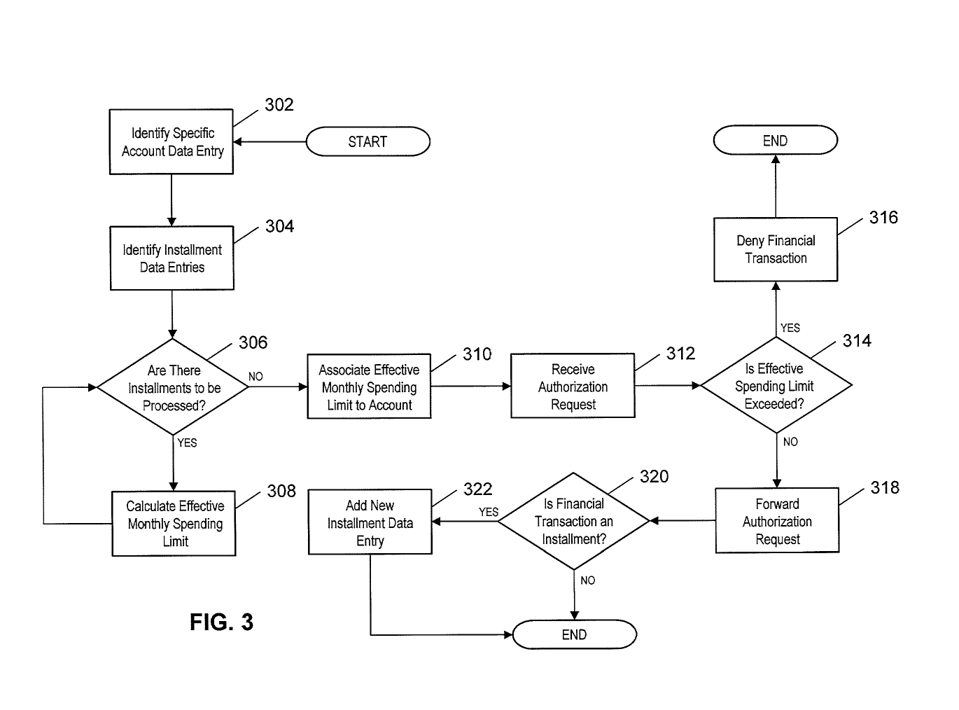

FIG. 3 illustrates a method for the identification of spending limits for a payment account and the processing of a financial transaction based thereon.

In step 302, the processing unit 204 of the processing server 106 may identify a specific account data entry in the account database 208. In some instances, step 302 may be prompted by the receipt of a new installment data entry including an account identifier included in the specific account data entry. In other instances, step 302 may be prompted by the receipt of an authorization request for a financial transaction including the account identifier included in the specific account data entry as indicating the related payment account for funding of the financial transaction. In another instance, step 302 may be prompted by the start of a new calendar month. Additional situations in which step 302 may be initiated, and which account identifier may be used to identify the specific account data entry, will be apparent to persons having skill in the relevant art.

In step 304, the processing unit 204 may identify, in the installment database 210, one or more installment data entries including the account identifier included in the specific account data entry. Then, in step 306, the processing unit 204 may determine if there are remaining identified installment data entries waiting to been processed. If there are, then, in step 308, the processing unit 204 may calculate a new effective monthly spending limit based on the base monthly spending limit included in the specific account data entry, or previously calculated effective monthly spending limit, and the installment amount included in the corresponding installment data entry.

Once each of the identified at least one installment data entry has been processed, then, in step 310, the processing unit 310 may associate, in the account database 208, the calculated effective monthly spending limit with the specific account data entry. In step 312, the receiving unit 202 of the processing server 106 may receive an authorization request for a financial transaction involving the payment account related to the specific account data entry. In step 314, the processing unit 204 may identify, based on a transaction amount included in the authorization request, if the effective monthly spending limit associated with the specific account data entry will be exceeded by approval of the financial transaction. In some embodiments, the identification made in step 314 may be further based on a monthly spending amount included in the specific account data entry.

If the effective spending limit is to be exceeded by the financial transaction, then, in step 316, the transmitting unit 206 may transmit an authorization response to the acquirer 110 in response to the authorization request indicating denial of the financial transaction. In some instances, the transmitting unit 206 may further transmit a notification to the consumer 102 and/or the issuer 104 indicating the denial of the financial transaction. Notifications may be transmitting to the consumer 102 via methods that will be apparent to persons having skill in the relevant art, such as e-mail, traditional mail, short message service (SMS) message, an application program, telephone, etc. In some instances, the specific account data entry may include information regarding the transmission of notifications to the consumer 102, such as a preferred method of communication and contact information.

If, in step 314, the processing unit 204 determines that the effective spending limit will not be exceeded by the financial transaction, then, in step 318, the transmitting unit 206 may forward the authorization request to the issuer 104 and/or the payment network 112 for processing. In some embodiments, step 314 may also include receiving, by the receiving unit 202, an authorization response, and the forwarding of the authorization response to the acquirer 110 by the transmitting unit 206.

In step 320, the processing unit 204 may determine if the financial transaction is an installment transaction, such as by identifying a corresponding data element included in the authorization request. Additional methods for identifying a financial transaction as an installment transaction will be apparent to persons having skill in the relevant art. If the transaction is determined to be an installment transaction, then, in step 322, the processing unit 204 may add a new installment data entry corresponding to the financial transaction in the installment database 210. In one embodiment, the new installment data entry may include the account identifier included in the specific account data entry, and an installment amount indicated in the authorization request. In a further embodiment, the installment data entry may further include an installment term, which may represent the length of the installment (e.g., length of time, number of payments, etc.). Additional information that may be stored detailing an installment transaction will be apparent to persons having skill in the relevant art.

### Method for Processing of a Financial Transaction Subject to Spending Limits

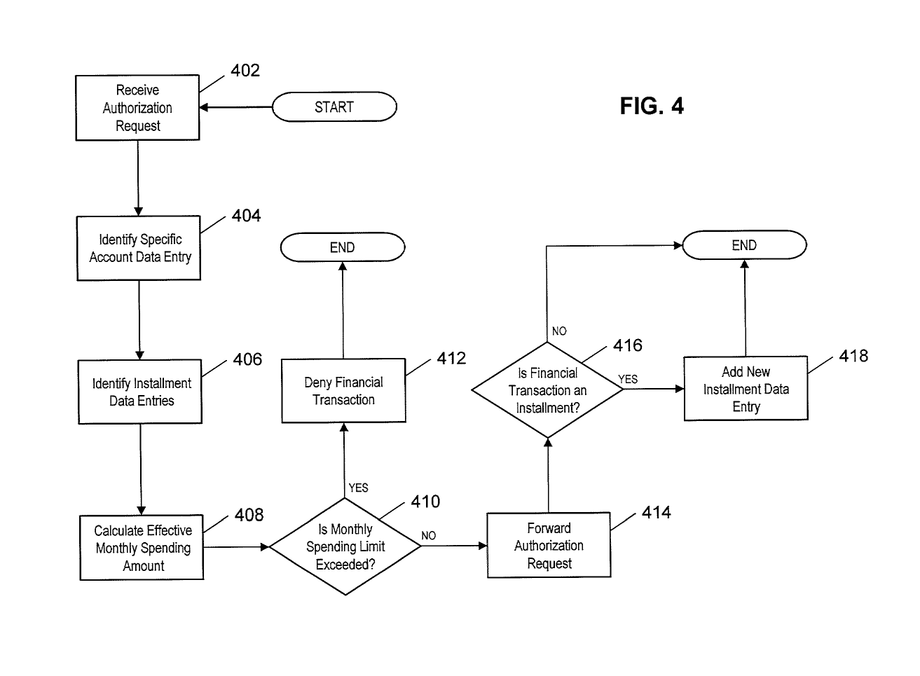

FIG. 4 illustrates a method for the processing of a financial transaction, which may be funded by a payment account subject to spending limits, which may be further subject to ongoing installment transactions.

In step 402, the receiving unit 202 of the processing server 106 may receive an authorization request for a financial transaction, the authorization request including at least a transaction amount and an account identifier associated with a payment account used to fund the financial transaction. In step 404, the processing unit 204 may identify, in the account database, a specific account data entry where the account identifier included in the specific account data entry corresponds to the account identifier included in the authorization request. The specific account data entry may include at least a monthly spending limit and a monthly spending amount.

In step 406, the processing unit 204 may identify, in the installment database 210, one or more installment data entries where the account identifier included in the corresponding installment data entry corresponds to the account identifier included in the authorization request. Each installment data entry may include at least an installment amount. Then, in step 408, the processing unit 204 may calculate an effective monthly spending amount based on the monthly spending amount included in the specific account data entry and the installment amount included in each of the at least one installment data entry.

In step 410, the processing unit 204 may determine if the monthly spending limit included in the specific account data entry is exceeded based on the calculated effective monthly spending amount. In some embodiments, the effective monthly spending amount may further include the transaction amount included in the authorization request, such as to determine if the monthly spending amount would be exceeded by the financial transaction being processed. If the spending limit would be exceeded, then, in step 412, the processing server 106 may deny the financial transaction. Denying the financial transaction may include transmitting, via the transmitting unit 206, an authorization response indicating denial of the transaction to the acquirer 110 and/or transmitting a notification to the consumer 102 and/or issuer 104 indicating the denial of the financial transaction.

If, in step 410, the processing unit 204 determines that the monthly spending limit would not be exceeded, then, in step 414, the transmitting unit 206 may forward the authorization request to the issuer 104 and/or payment network 112 for processing. In step 416, the processing unit 204 may identify if the financial transaction is an installment transaction. In one embodiment, the authorization request may include a data element indicating the financial transaction as an installment transaction. If the transaction is not an installment transaction, then the process may be completed. If the transaction is an installment transaction, then, in step 418, the processing unit 204 may store a new installment data entry in the installment database 210 corresponding to the financial transaction.

### Graphical User Interface

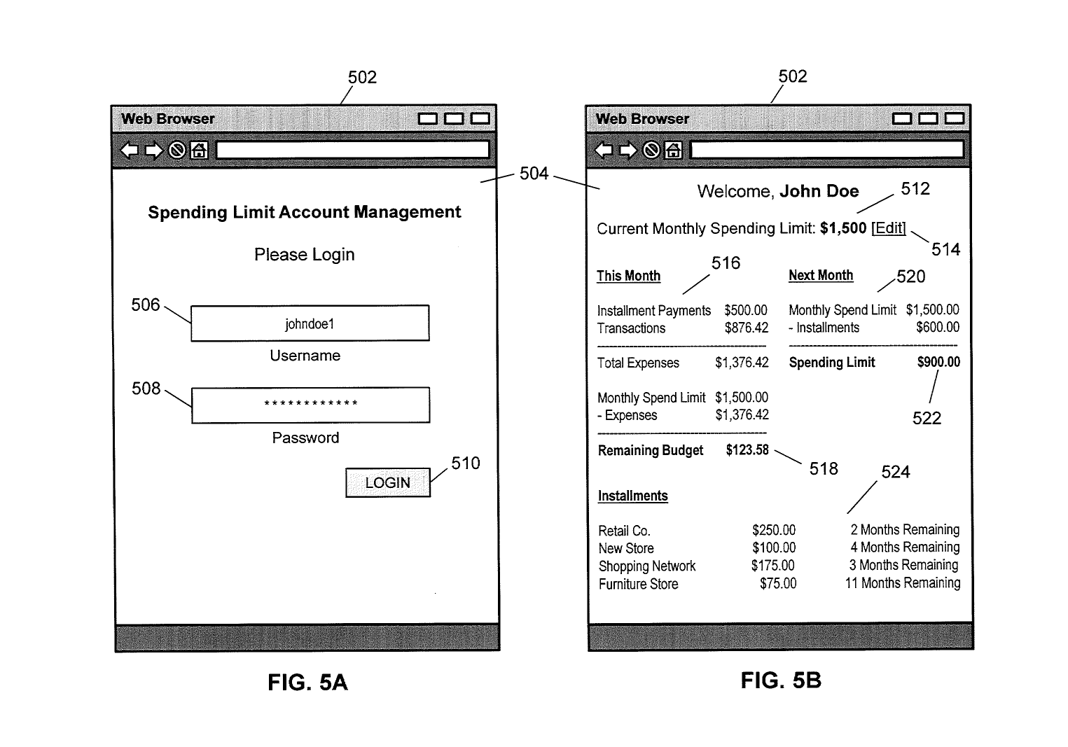

FIGS. 5A and 5B illustrate an exemplary graphical user interface for the managing of monthly spending limits for a payment account subject to ongoing installment transactions. It will be apparent to persons having skill in the relevant art that the interface illustrated in FIGS. 5A and 5B is provided as an example, and that other interfaces may be suitable for use in performing the functions as disclosed herein. Furthermore, although the interface illustrated herein is illustrated as being accessed via an Internet webpage, it will be apparent to persons having skill in the relevant art that the interface may be accessed by a user (e.g., the consumer 102) via other systems and methods, such as via an application program on a computer or smartphone, etc.

FIG. 5A illustrates a webpage 504. The webpage 504 may be displayed by a web browser 502 or other similar application program that may be executed by a processor of a computing device, such as a desktop computer, laptop computer, notebook computer, tablet computer, smart phone, etc. The webpage 504 as illustrated in FIG. 5A may display a login screen, which may enable the consumer 102 to authenticate themselves and access account information.

The login screen of the webpage 504 may include a username field 506 and a password field 508. The consumer 102 may enter a username into the username field 506, which may be a unique value associated with the consumer 102 used for authentication. Other values suitable for use in authenticating the consumer 102 will be apparent to persons having skill in the relevant art, such as an account identifier corresponding to the payment account associated with the consumer 102.

The password field 508 may similarly enable the consumer 102 to input a password for stronger authentication and security. The webpage 504 may also include a login button 510. When the consumer 102 interacts with the login button 510, the webpage 504 may be configured to transmit the data entered into the username field 506 and the password field 508 to the hosting server (e.g., the processing server 106 or a web hosting server operated by or on behalf of the processing server 106). The hosting server may then authenticate the consumer 102 based on the received information.

If the consumer 102 is successfully authenticated, then the webpage 504 may be configured to display an account information page as illustrated in FIG. 5B. The account information page may display information related to the payment account associated with the consumer 102 including spending limits and installment transactions. For example, as illustrated in FIG. 5B, the webpage 504 may display a monthly spending limit 512. The monthly spending limit 512 may be the monthly spending limit included in an account data entry including an account identifier corresponding to the payment account associated with the consumer 102. The webpage 504 may also include an edit button 514, which, when interacted with by the consumer 102, may prompt the consumer 102 to change or modify their monthly spending limit 512.

The webpage 504 may also include a monthly summary 516. The monthly summary 516 may display an itemized list of account information for the present month to the consumer 102. As illustrated in FIG. 5B, the monthly summary 516 may include the total installment amount for all installments associated with the payment account and the monthly spending amount for the payment account. The monthly summary 516 may also display the total amount of the expenses as calculated based on the total installment amount and monthly spending amount, which may then be used to calculate a remaining budget 518 for display. The remaining budget 518 may be an amount which the consumer 102 may spend during the remainder of the month to not exceed the monthly spending limit 512 in light of all ongoing installment transactions for which payment is/was due during that month.

The webpage 504 may also display an upcoming month summary 520. The upcoming month summary 520 may include account information for the following month, such as based on installment transactions that have not gone into effect as of the present month. The upcoming month summary 520 may also include an upcoming effective spending limit 522, which may represent the effective monthly spending limit for the following month after deduction for due installment payments.

The webpage 504 may also include an installment summary 524. The installment summary 524 may include information for each ongoing installment transaction associated with the payment account. As illustrated in FIG. 5B, the installment summary 524 may include a merchant involved with the corresponding installment, the installment amount, and the length of time remaining for the installment. Additional information that may be display on the webpage 504 will be apparent to persons having skill in the relevant art, such as notification settings, notification limits, preferred contact methods, limits for additional payment numbers associated with the payment account, etc.

### Exemplary Method for Identifying a Spending Budget for a Payment Account

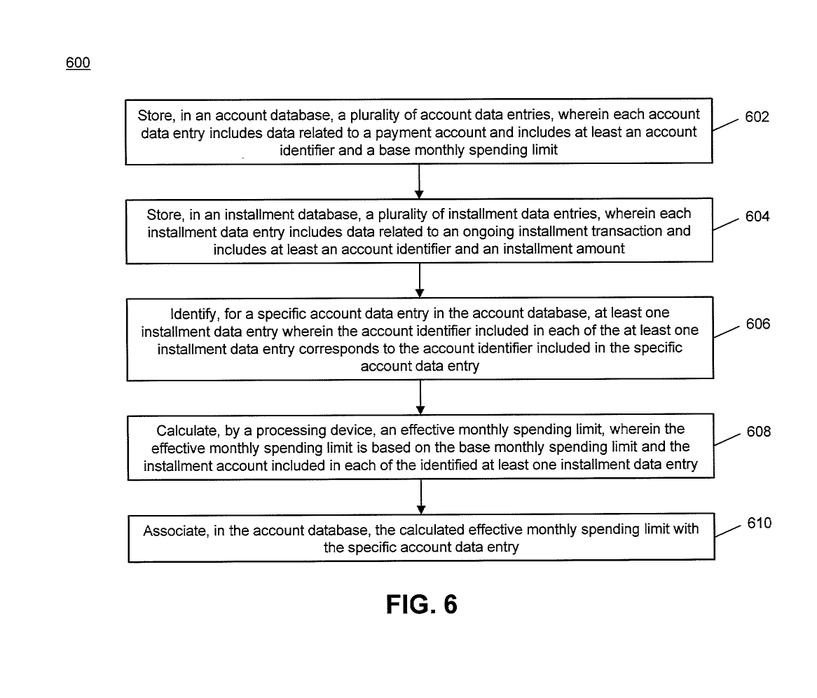

FIG. 6 illustrates a method 600 for identifying a spending budget for a payment account.

In step 602, a plurality of account data entries may be stored in an account database (e.g., the account database 208), wherein each account data entry includes data related to a payment account and includes at least an account identifier and a base monthly spending limit. In step 604, a plurality of installment data entries may be stored in an installment database (e.g., the installment database 210), wherein each installment data entry includes data related to an ongoing installment transaction and includes at least an account identifier and an installment amount. In one embodiment, each installment data entry may further include a number of remaining payments.

In step 606, at least one installment data entry may be identified (e.g., by the processing unit 204) for a specific account data entry in the account database 208, wherein the account identifier included in each of the at least one installment data entry corresponds to the account identifier included in the specific account data entry. In step 608, an effective monthly spending limit may be calculated, by a processing device (e.g., the processing unit 204), wherein the effective monthly spending limit is based on the base monthly spending limit and the installment amount included in each of the identified at least one installment data entry. In step 610, the calculated effective monthly spending limit may be associated, in the account database 208, with the specific account data entry.

In one embodiment, the method 600 may further include: receiving, by a receiving device (e.g., the receiving unit 202), an authorization request for a financial transaction, wherein the authorization request includes at least a transaction amount and the account identifier included in the specific account data entry; updating, by the processing device 204, the authorization request to indicate if the transaction amount is less than or equal to the effective monthly spending limit or exceeds the effective monthly spending limit; and transmitting, by a transmitting device (e.g., the transmitting unit 206), the authorization request for approval or denial of the financial transaction. In a further embodiment, the authorization request may be transmitted to a payment network (e.g., the payment network 112) or an issuer (e.g., the issuer 104).

In another further embodiment, the financial transaction may be an installment transaction. In an even further embodiment, the method 600 may include: storing, in the installment database 210, a new installment data entry related to the financial transaction; and updating, in the account database 208, the effective monthly spending limit associated with the specific account data entry based on an installment amount, wherein the authorization request includes the installment amount, the new installment data entry includes the account identifier included in the specific account data entry and the installment amount, and the installment amount is a portion of the transaction amount.

In another further embodiment, each account data entry may further include at least one spend control, the authorization request may further include transaction data, and the authorization request may be transmitted for approval or denial if the financial transaction complies with the at least one spend control included in the specific account data entry based on the transaction data. The transaction data may include at least one of: merchant name, merchant identifier, product details, transaction time and/or date, geographic location, purchase order number, invoice number, and shipping information. The at least one spend control may be one of: transaction frequency, geographic location, time and/or date, transaction amount, merchant name purchase order number, and invoice number.

### Exemplary Method for Processing a Financial Transaction

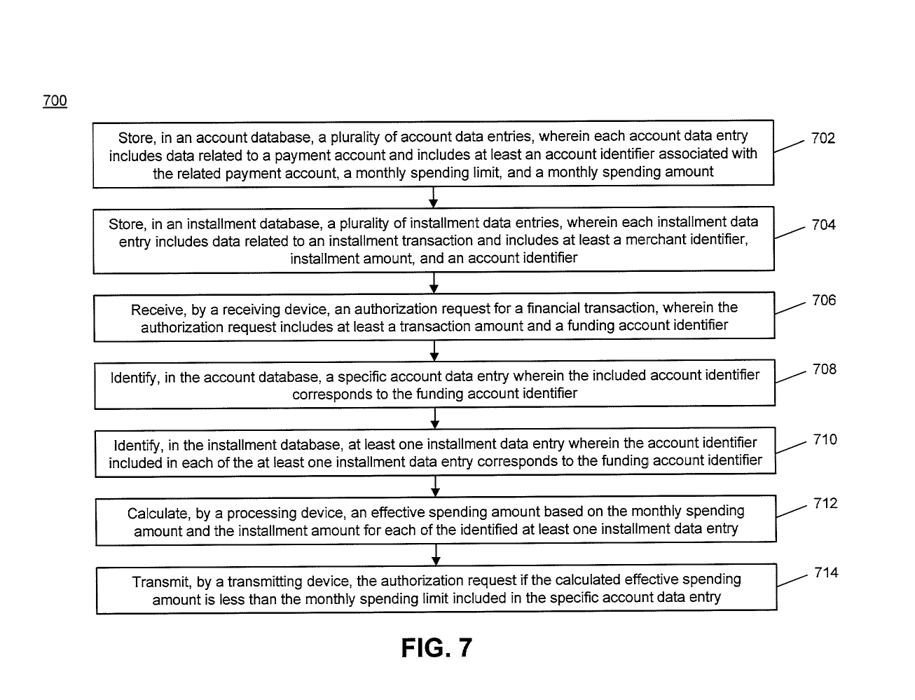

FIG. 7 illustrated a method 700 for processing a financial transaction funded by a payment account subject to a spending limit and an ongoing installment transaction.

In step 702, a plurality of account data entries may be stored in an account database (e.g., the account database 208), wherein each account data entry includes data related to a payment account and includes at least an account identifier associated with the related payment account, a monthly spending limit, and a monthly spending amount. In step 704, a plurality of installment data entries may be stored in an installment database (e.g., the installment database 210), wherein each installment data entry includes data related to an ongoing installment transaction and includes at least a merchant identifier, installment amount, and an account identifier. In some embodiments, each installment data entry may further include a number of remaining payments.

In step 706, an authorization request for a financial transaction may be received, by a receiving device (e.g., the receiving unit 202), wherein the authorization request includes at least a transaction amount and a funding account identifier. In one embodiment, the financial transaction may be an installment transaction. In step 708, a specific account data entry may be identified, in the account database 208, wherein the included account identifier corresponds to the funding account identifier. In step 710, at least one installment data entry may be identified in the installment database 210, wherein the account identifier included in each of the at least one installment data entry corresponds to the funding account identifier.

In step 712, an effective spending amount may be calculated, by a processing device (e.g., the processing unit 204), based on the monthly spending amount and the installment amount for each of the identified at least one installment data entry. In step 714, the authorization request may be transmitted, by a transmitting device (e.g., the transmitting unit 206) if the calculated effective spending amount is less than the monthly spending limit included in the specific account data entry. In one embodiment, the authorization request may be transmitted to a payment network (e.g., the payment network 112) or an issuer (e.g., the issuer 104).

In embodiments where the financial transaction may be an installment transaction, the method 700 may further include: storing, in the installment database 210, a new installment data entry related to the financial transaction; and updating, in the specific account data entry, the monthly spending amount based on a portion of the transaction amount, wherein the authorization request further includes a merchant identification and an installment amount, the new installment data entry includes the merchant identification, funding account identifier, and the installment amount, and the portion of the transaction amount is the installment amount.

### Computer System Architecture

FIG. 8 illustrates a computer system 800 in which embodiments of the present disclosure, or portions thereof, may be implemented as computer-readable code. For example, processing server 106 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 6, and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3, 4, 6, and 7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for identify spending limits or budgets of a payment account and processing financial transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying a spending budget for a payment account, comprising:
storing, in an account database, a plurality of account data entries, wherein each account data entry includes data related to a payment account and includes at least an account identifier and a base monthly spending limit;
storing, in an installment database, a plurality of installment data entries, wherein each installment data entry includes data related to an ongoing installment transaction and includes at least an account identifier and an installment amount;
identifying, for a specific account data entry in the account database, at least one installment data entry wherein the account identifier included in each of the at least one installment data entry corresponds to the account identifier included in the specific account data entry;
calculating, by a processing device, an effective monthly spending limit, wherein the effective monthly spending limit is based on the base monthly spending limit and the installment amount included in each of the identified at least one installment data entry; and
associating, in the account database, the calculated effective monthly spending limit with the specific account data entry.

2. The method of claim 1, further comprising:
receiving, by a receiving device, an authorization request for a financial transaction, wherein the authorization request includes at least a transaction amount and the account identifier included in the specific account data entry;
updating, by the processing device, the authorization request to indicate if the transaction amount is less than or equal to the effective monthly spending limit or exceeds the effective monthly spending limit; and
transmitting, by a transmitting device, the authorization request for approval or denial of the financial transaction.

3. The method of claim 2, wherein the authorization request is transmitted to a payment network or issuer.

4. The method of claim 2, wherein the financial transaction is an installment transaction.

5. The method of claim 4, further comprising:
storing, in the installment database, a new installment data entry related to the financial transaction; and
updating, in the account database, the effective monthly spending limit associated with the specific account data entry based on an installment amount, wherein
the authorization request includes the installment amount,
the new installment data entry includes the account identifier included in the specific account data entry and the installment amount, and
the installment amount is a portion of the transaction amount.

6. The method of claim 2, wherein
each account data entry further includes at least one spend control,
the authorization request further includes transaction data, and
the authorization request is transmitted for approval or denial if the financial transaction complies with the at least one spend control included in the specific account data entry based on the transaction data.

7. The method of claim 6, wherein the transaction data includes at least one of: merchant name, merchant identifier, product details, transaction time and/or date, geographic location, purchase order number, invoice number, and shipping information.

8. The method of claim 6, wherein the at least one spend control is one of:
transaction frequency, geographic location, time and/or date, transaction amount, merchant name, purchase order number, and invoice number.

9. The method of claim 1, wherein each installment data entry further includes a number of remaining payments.

10. A method for processing a financial transaction, comprising:
storing, in an account database, a plurality of account data entries, wherein each account data entry includes data related to a payment account and includes at least an account identifier associated with the related payment account, a monthly spending limit, and a monthly spending amount;
storing, in an installment database, a plurality of installment data entries, wherein each installment data entry includes data related to an installment transaction and includes at least a merchant identifier, an installment amount, and an account identifier;
receiving, by a receiving device, an authorization request for a financial transaction, wherein the authorization request includes at least a transaction amount and a funding account identifier;
identifying, in the account database, a specific account data entry wherein the included account identifier corresponds to the funding account identifier;
identifying, in the installment database, at least one installment data entry wherein the account identifier included in each of the at least one installment data entry corresponds to the funding account identifier;
calculating, by a processing device, an effective spending amount based on the monthly spending amount and the installment amount for each of the identified at least one installment data entry; and
transmitting, by a transmitting device, the authorization request if the calculated effective spending amount is less than the monthly spending limit included in the specific account data entry.

11. The method of claim 10, wherein the financial transaction is an installment transaction.

12. The method of claim 11, further comprising:
storing, in the installment database, a new installment data entry related to the financial transaction; and
updating, in the specific account data entry, the monthly spending amount based on a portion of the transaction amount, wherein
the authorization request further includes a merchant identification and an installment amount,
the new installment data entry includes the merchant identification, funding account identifier, and the installment amount, and
the portion of the transaction amount is the installment amount.

13. The method of claim 10, wherein each installment data entry further includes a number of remaining payments.

14. The method of claim 10, wherein the authorization request is transmitted to a payment network or an issuer.

15. A system for identifying a spending budget for a payment account, comprising:
an account database configured to store a plurality of account data entries, wherein each account data entry includes data related to a payment account and includes at least an account identifier and a base monthly spending limit;
an installment database configured to store a plurality of installment data entries, wherein each installment data entry includes data related to an ongoing installment transaction and includes at least an account identifier and an installment amount; and
a processing device configured to
identify, for a specific account data entry in the account database, at least one installment data entry wherein the account identifier included in each of the at least one installment data entry corresponds to the account identifier included in the specific account data entry,
calculate an effective monthly spending limit, wherein the effective monthly spending limit is based on the base monthly spending limit and the installment amount included in each of the identified at least one installment data entry, and
associate, in the account database, the calculated effective monthly spending limit with the specific account data entry.

16. The system of claim 15, further comprising:
a processing device; and
a receiving device configured to receive an authorization request for a financial transaction, wherein the authorization request includes at least a transaction amount and the account identifier included in the specific account data entry, wherein
the processing device is further configured to update the authorization request to indicate if the transaction amount is less than or equal to the effective monthly spending limit or exceeds the effective monthly spending limit, and
the transmitting device is configured to transmit the authorization request for approval or denial of the financial transaction.

17. The system of claim 16, wherein the transmitting device is configured to transmit the authorization request to a payment network or issuer.

18. The system of claim 16, wherein the financial transaction is an installment transaction.

19. The system of claim 18, wherein
the processing device is further configured to
store, in the installment database, a new installment data entry related to the financial transaction, and
update, in the account database, the effective monthly spending limit associated with the specific account data entry based on an installment amount;
the authorization request includes the installment amount;
the new installment data entry includes the account identifier included in the specific account data entry and the installment amount; and
the installment amount is a portion of the transaction amount.

20. The system of claim 16, wherein
each account data entry further includes at least one spend control,
the authorization request further includes transaction data, and
the transmitting device is further configured to transmit the authorization request for approval or denial if the financial transaction complies with the at least one spend control included in the specific account data entry based on the transaction data.

21. The system of claim 20, wherein the transaction data includes at least one of: merchant name, merchant identifier, product details, transaction time and/or date, geographic location, purchase order number, invoice number, and shipping information.

22. The system of claim 20, wherein the at least one spend control is one of: transaction frequency, geographic location, time and/or date, transaction amount, merchant name, purchase order number, and invoice number.

23. The system of claim 15, wherein each installment data entry further includes a number of remaining payments.

24. A system for processing a financial transaction, comprising:
an account database configured to store a plurality of account data entries, wherein each account data entry includes data related to a payment account and includes at least an account identifier associated with the related payment account, a monthly spending limit, and a monthly spending amount;
an installment database configured to store a plurality of installment data entries, wherein each installment data entry includes data related to an installment transaction and includes at least a merchant identifier, an installment amount, and an account identifier;
a receiving device configured to receive an authorization request for a financial transaction, wherein the authorization request includes at least a transaction amount and a funding account identifier;
a processing device configured to
identify, in the account database, a specific account data entry wherein the included account identifier corresponds to the funding account identifier,
identify, in the installment database, at least one installment data entry wherein the account identifier included in each of the at least one installment data entry corresponds to the funding account identifier, and
calculate an effective spending amount based on the monthly spending amount and the installment amount for each of the identified at least one installment data entry; and
a transmitting device configured to transmit the authorization request if the calculated effective spending amount is less than the monthly spending limit included in the specific account data entry.

25. The system of claim 24, wherein the financial transaction is an installment transaction.

26. The system of claim 25, wherein
the processing device is further configured to
store, in the installment database, a new installment data entry related to the financial transaction, and
update, in the specific account data entry, the monthly spending amount based on a portion of the transaction amount;
the authorization request further includes a merchant identification and an installment amount;
the new installment data entry includes the merchant identification, funding account identifier, and the installment amount; and
the portion of the transaction amount is the installment amount.

27. The system of claim 24, wherein each installment data entry further includes a number of remaining payments.

28. The system of claim 24, wherein the transmitting device is further configured to transmit the authorization request to a payment network or an issuer.
